(19) United States
(12) Patent Application Publication
(10) Pub. No.: US 2009/0313760 A1
(43) Pub. Date: Dec. 24, 2009

(54) Pregnancy Support Cushion

(76) Inventors: Vanessa Robyn Blake, Oxfordshire (GB); Stephen Francis Blake, Oxfordshire (GB)

Correspondence Address: HARRINGTON & SMITH, PC, 4 RESEARCH DRIVE, Suite 202, SHELTON, CT, 06484-6212, US

(21) Appl. No.: 11/988,245

(22) PCT Filed: Jun. 23, 2006
(86) PCT No.: PCT/GB2006/002312

§ 371 Date: Apr. 13, 2009

(30) Foreign Application Priority Data
Jul. 6, 2005 (GB) 0513795.5

(51) Int. Cl. A61G 7/065; A47C 20/02

(52) U.S. Cl. 5/632; 5/652; 5/631

(57) ABSTRACT

A support cushion for supporting a person (e.g. a pregnant woman) lying on their side includes a first cushion part configured to support the person's back, a second cushion part spaced-apart from the first cushion part and configured to support the front of the person's abdomen and/or the person's legs, and a connecting part that connects the first cushion part to the second cushion part, the connecting part configured to extend under the person's side. The first and second cushion parts may be elongate and generally in the form of cylinders, and the connecting part may be in the form of a flexible cushioned panel. The second cushion part may support a pregnant woman's swollen abdomen and may extend between, and support, her legs.

The present invention relates to support cushions (including support pillows). The invention has particular utility in providing support for pregnant women, particularly during the later months of pregnancy (and especially in the third trimester), but the invention is applicable more generally for the provision of support for recumbent persons.

It is very well known amongst pregnant women and their partners, mothers, midwives and other healthcare professionals, that pregnant women commonly experience sleeping difficulties because of problems encountered in adopting and maintaining a comfortable position when lying down. Discomfort is often encountered because, at least in the later stages of pregnancy, the pregnant woman is generally unable to sleep lying on her back due to a risk of restricting her blood circulation and that of her unborn baby, sleeping on her front is not generally possible, and while sleeping on her side is the only realistic position, this too is often uncomfortable for a variety of reasons. Firstly, the weight of the unborn baby and the woman's increase in size generally causes an uncomfortable downward pull on her lower back and the front of her abdomen. Secondly, the weight of the woman's legs, lying on one side, increases pressure on her lower back and swollen abdomen (commonly referred to as her ‘bump’). Thirdly, support is often needed in the ‘small’ of the woman's back, at her waist, and between her knees.

A variety of differing sleep support cushions are available. However, they often have the problems that they are too large and encroach into the woman's partner's sleeping space, and when the woman wishes to turn over to sleep on her opposite side, the whole cushion needs to be moved. The present inventors have also found that known cushions generally do not provide an entirely comfortable sleeping position, because they do not provide support to all of the key areas often required, i.e.: the swollen abdomen (the ‘bump’); the small of the back; the knees; and around the waist. Consequently, if all of these areas are to be supported, multiple cushions need to be used, with the concomitant disadvantages of taking up too much space in the bed, lack of convenience, lack of manoeuvrability, and lack of effectiveness.

The present invention seeks to provide a support cushion that solves these problems.

Accordingly, a first aspect of the invention provides a support cushion for supporting a person lying on their side, comprising a first cushion part configured to support the person's back, a second cushion part spaced-apart from the first cushion part and configured to support the front of the person's abdomen and/or the person's legs, and a connecting part that connects the first cushion part to the second cushion part, the connecting part configured to extend under the person's side.

The invention has the advantage that, by the provision of two spaced-apart cushion parts connected by a connecting part of the cushion, pre-arranged support can be provided in the correct positions for a person's back and the front of their abdomen and/or their legs, without the need to attempt to position separate support cushions in those positions. Also, because the first and second cushion parts are connected together in the correct spatial arrangement, if the person moves (for example by turning onto their opposite side) the cushion parts may either remain in place and simply support opposite parts of the person's body, or the support cushion may conveniently be re-oriented as a unit such that the cushion parts may easily be put in the correct new positions.

In preferred embodiments of the invention, one or each of the first cushion part and the second cushion part is elongate in shape.

Accordingly, a second aspect of the invention provides a support cushion for supporting a recumbent person, comprising an elongate first cushion part, an elongate second cushion part spaced-apart from the first cushion part, and a connecting part that connects the first cushion part to the second cushion part.

It is to be understood that any feature of either aspect of the invention may be a feature of the other aspect of the invention.

Preferably, one or each of the first cushion part and the second cushion part is substantially cylindrical (which term is intended to encompass flattened-cylindrical shapes, and approximately D-shaped cross-sections, for example).

By providing the first and/or second cushion part as elongate and/or substantially cylindrical, the support cushion according to the invention can have the advantage of being sufficiently narrow so that it does not encroach significantly (if at all) into the sleeping space of the person's partner beside them.

In preferred embodiments of the invention, the connecting part, which preferably is flexible, is substantially flat. The connecting part may, for example, have the form of a panel, especially a cushioned panel. The connecting part preferably enables the user to modify the distance between the first and second cushion parts, e.g. by placing one or more folds in the connecting part to make it shorter, or by removing any such folds to make it longer again. Consequently, the separation between the first and second cushion parts preferably can be modified by the user to suit their particular body shape and size, or their particular needs at any time. The first and second cushion parts are spaced apart preferably by a maximum of about 50 cm, for example about 30-40 cm.

The second cushion part preferably is longer than the first cushion part. For example, the second cushion part may be at least 1.5 times the length of the first cushion part, preferably at least twice the length of the first cushion part, e.g. three times the length of the first cushion part. The second cushion part preferably is configured to support the front of the person's abdomen and the person's legs. Advantageously, the first cushion part and at least a first portion of the second cushion part may be connected by the connecting part such that normally they are substantially parallel to each other. The second cushion part may, at least in some embodiments of the invention, include a second portion (e.g. an elongate second portion) that is oriented such that it is inclined and/or curved with respect to the first portion, in a direction towards the first cushion part. That is, at least a second portion of the second cushion part preferably is not substantially parallel to the first cushion part. The second portion of the second cushion part preferably is configured to support the person's legs, for example by extending between the person's legs.

As mentioned above, the support cushion according to the invention preferably is configured to support a pregnant woman. In particular, the second cushion part may be configured to support a pregnant woman's swollen abdomen and/or her legs (e.g. by extending between her legs). However, as also mentioned above, the invention is not limited to use by pregnant women, and may provide useful support to any person.

The support cushion is versatile and may be used in many different ways. A particularly useful function for the support cushion is as a support when feeding (e.g. breast-feeding) a baby. For example, with the baby's mother (or other carer) sitting comfortably in a chair, the support cushion may be positioned such that the second portion (leg support portion) of the second part supports the small of the mother's back, with the first part and the remainder of the second part in front of the mother. The first part and the connecting part of the cushion may be wrapped or folded at least partially around the first portion of the second part to create a “cradle” shaped support for the baby. A separate additional (conventional) cushion may, for example, be used as a support for the mother's arm which supports the cradle shape and the baby.

The support cushion according to the invention and/or each of the cushion parts, preferably is formed from a flexible outer cloth case stuffed or padded with a mass of soft material, e.g. fibres and/or down and/or polymer foam material. The outer cloth case preferably is formed from woven fibres, e.g. of cotton and/or synthetic fibres (especially a mixture of cotton and polyester fibres). The stuffing preferably comprises hollow synthetic fibres. The connecting part of the support cushion may, for example, comprise a cloth panel (or generally any cloth or fibre connecting part). Preferably, the connecting part comprises a padded or stuffed panel, especially a quilted panel, i.e. a generally flat flexible outer cloth case stuffed or padded with soft material. The cloth case and the stuffing preferably are fire-retardant. The first and second cushion parts preferably are attached to the connecting part by stitching.

However, the support cushion according to the invention and/or each of the cushion parts and/or the connecting part, may generally be formed from any resiliently compressible flexible material. For example, any or all of the parts of the support cushion may be formed from polymeric foam material, other polymeric material, inflatable material, etc. Thus, the support cushion may, for example, be formed from a single piece of polymer material, or a plurality of pieces of polymer material attached to each other. Additionally or alternatively, the support cushion may comprise an inflatable cushion, e.g. with some or all of its resilience being provided by the containment of gas (e.g. air) within it.

A preferred embodiment of the invention will now be described, by way of example, with reference to the accompanying drawings, of which:

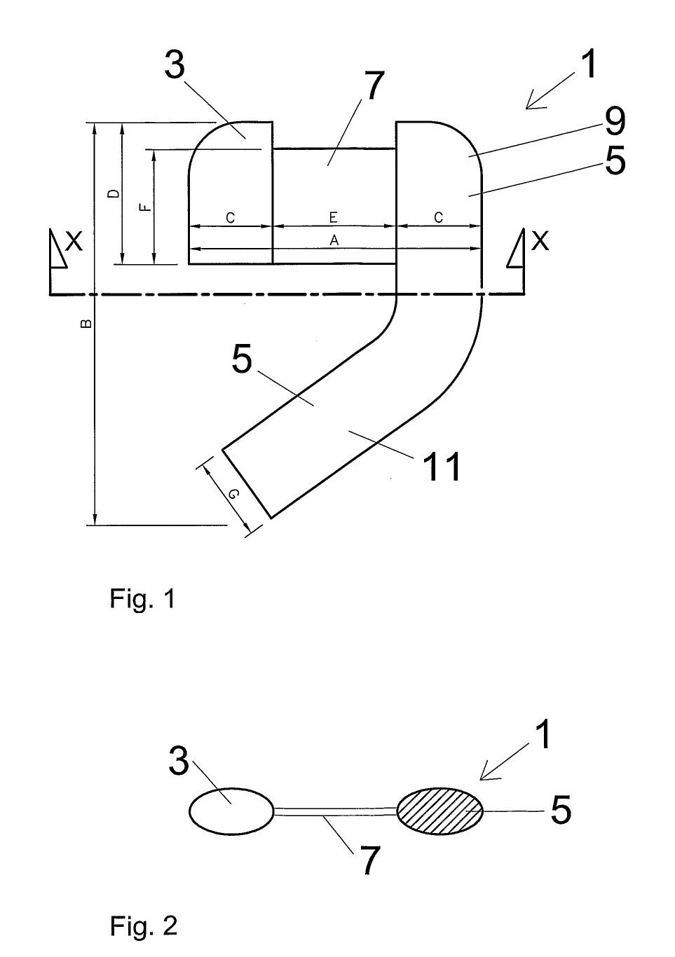

FIG. 1 shows a support cushion according to the invention, in schematic plan view; and

FIG. 2 shows the support cushion of FIG. 1 in schematic cross-sectional view, along line X-X.

FIGS. 1 and 2 show an embodiment of a support cushion 1 according to the invention, comprising a first cushion part 3, a second cushion part 5 spaced-apart from the first cushion part, and a connecting part 7 that connects the first cushion part to the second cushion part. The support cushion 1 is configured to support a person (especially a pregnant woman) lying on their side.

The first cushion part 3 is configured to support the person's back, especially the small of the back. The second cushion part 5 is configured to support the front of the person's abdomen, especially a pregnant woman's ‘bump’, and the person's legs (by extending between the legs, especially to support the knees). More particularly, the second cushion part 5 comprises a first portion 9 which supports the woman's bump, and which is located directly on the opposite side of the connecting part 7 from the first cushion part 3, and oriented substantially parallel to the first cushion part 3. A second portion 11 of the second cushion part 5 is configured to extend between the woman's legs to separate and support her knees, thereby reducing pressure on her knees, back and bump. The second portion 11 comprises an extension of the second cushion part 5 that is inclined with respect to the first portion 9 in a direction towards the first cushion part 3. In the embodiment of the invention illustrated in FIG. 1, the second cushion part 5 is approximately three times the length of the first cushion part 3. Finally, the connecting part 7 is configured to extend under the person's side (particularly their waist). The flexible connecting part 7, which comprises a padded or quilted panel, keeps the support cushion 1 in position under the weight of the sleeper, provides support to the sleeper's waist, and allows the distance between the first and second cushion parts to be adjusted, by adding or removing folds in the connecting part.

The support cushion 1 preferably has the following dimensions (shown in FIG. 1). The dimension A, i.e. the total width of the cushion, preferably is in the range of 50 to 90 cm, more preferably 60 to 75 cm, for example approximately 67-69 cm. The dimension B, i.e. the total length of the cushion, preferably is in the range of 70 to 130 cm, more preferably 80 to 120 cm, for example approximately 97-103 cm. The width C (i.e. the horizontal diameter) of each parallel cushion part 3, 5, preferably is in the range of 10 to 20 cm, for example approximately 14-18 cm. The width G of the second portion 11 of the second cushion part may be approximately the same as the width C of the first portion 9, or alternatively the width G may be greater than that of the first portion 9, e.g. the width G may be in the range of 25-30 cm, for example approximately 28 cm. Each cushion part 3, 5, preferably is either substantially cylindrical or flattened cylindrical (in which case the height of each cushion part will be slightly less than its width C, e.g. approximately 12 cm). The length D of the first cushion part 3 preferably is in the range of 20 to 50 cm, for example approximately 35 cm. The width E of the connecting part 7 (i.e. the separation between the first and second cushion parts 3, 5) preferably is in the range of 30 to 50 cm, for example approximately 33-39 cm. The length F of the connecting part 7 preferably is in the range of 15 to 50 cm, for example approximately 30 cm. The thickness (depth) of the connecting part 7 may be in the range of 0.5 to 10 cm, e.g. approximately 4 to 5 cm. As mentioned above, the second cushion part 5 may, for example, be at least 1.5 times the length of the first cushion part 3, preferably at least twice the length of the first cushion part, e.g. approximately three times the length of the first cushion part. For example, the first portion 9 of the second cushion part 5 may be 50-60 cm in length, e.g. approximately 55 cm in length, and the second portion 11 of the second cushion part 5 may also be 50-60 cm in length, e.g. approximately 55 cm in length.

FIG. 2 shows the support cushion of FIG. 1 in schematic cross-sectional view, along line X-X. It can be seen that each of the first and second cushion parts 3 and 5 has the form of a partially flattened cylinder (although other shapes are possible, e.g. approximate D-shapes), and the connecting part 7 has the form of a generally flat padded panel extending between the cushion parts. In FIG. 2, the support cushion is shown with the connecting part 7 in a taut state, such that it is lifted slightly from the surface (e.g. a bed) on which the support cushion is resting. However, in use when a person is lying on the support cushion, the connecting part 7 will not normally be taut (or will only be partially taut), and at least some of the connecting part will lie on the surface of the bed.

With the support cushion 1 oriented as shown in FIG. 1, the person (especially a pregnant woman) will normally be lying on her left side facing towards the right hand side of the page. The support cushion according to the invention therefore encourages the recommended sleeping position for a pregnant woman, especially in the second and third trimesters of pregnancy. (For anatomical reasons, the recommended sleeping position is for the woman to lie on her side, preferably on her left side.) The cushion provides comfort by supporting the pregnant woman's back, ‘bump’, knees and waist. It also helps to prevent the sleeper from rolling onto her back, thereby reducing the risk of pressure on the blood supply by the vena cava to the woman and the unborn baby. The support cushion also does not intrude into a partner's sleeping space because of its compact & contoured shape, thereby providing the double benefit of allowing a good night's rest for both parents to be. The cushion can also remain in the same place without having to be moved when changing sleeping position, because the second portion 11 of the second cushion part 5 can extend between the person's legs from either the front or the rear, the first cushion part 3 can support either the person's back or the front of their abdomen, and the first portion 9 of the second cushion part 5 can support either the front of the person's abdomen or their back.

The support cushion according to the invention therefore provides the following advantages: it is safe and easy to use; it provides support in key areas when sleeping in the recommended position; it is comfortable and compact; it can be easily adjusted; it provides an integrated solution in the form of a unitary support for both back and front; and it does not need to be moved when changing sleeping position (but can easily be moved if desired, because of its unitary construction). In preferred embodiments of the invention, the support cushion may have a removable cover, which preferably is washable.

1-17. (canceled)

18. A support cushion for supporting a person lying on their side, comprising a first cushion part configured to support the person's back, a second cushion part spaced-apart from the first cushion part and configured to support the front of the person's abdomen at a first portion thereof and the person's legs at a second portion thereof, and a connecting part that connects the first cushion part to the first portion of the second cushion part, the connecting part configured to extend under the person's side in the region of the abdomen, wherein the second portion of the second cushion part is inclined and/or curved with respect to the first portion in a direction towards the first cushion part.

19. A support cushion according to claim 18, in which one, or each, of the first cushion part and the second cushion part is elongate in shape.

20. A support cushion according to claim 18, wherein the connecting part is thin in depth compared with said cushion parts.

21. A support cushion for supporting a recumbent person, comprising an elongate first cushion part, an elongate second cushion part, having a first portion and a second portion spaced-apart from the first cushion part, and a connecting part that connects the first cushion part to the first part of the second cushion part, wherein the second portion of the second cushion part is inclined and/or curved with respect to the first portion in a direction towards the first cushion part, and the connecting part is thin in depth compared with said cushion parts.

22. A support cushion according to claim 18, in which one, or each, of the first cushion part and the second cushion part is substantially cylindrical.

23. A support cushion according to claim 18, in which the connecting part is substantially flat.

24. A support cushion according to claim 18, in which the connecting part has the form of a panel.

25. A support cushion according to claim 24, in which the connecting part has the form of a cushioned panel.

26. A support cushion according to claim 18, in which the second cushion part is longer than the first cushion part.

27. A support cushion according to claim 18, in which the first cushion part and the first portion of the second cushion part are connected by the connecting part such that normally they are substantially parallel to each other.

28. A support cushion according to claim 18, in which the second portion of the second cushion part is configured to extend between the person's legs.

29. A support cushion as in claim 18, wherein the connecting part is adapted such that folds can be introduced into it to allow the distance between the cushion parts to be adjusted.

30. A support cushion according to claim 18, in which the first and second cushion parts are spaced apart by a maximum of 50 cm.

31. A support cushion according to claim 18, in which the person for whom the support cushion is dimensioned to fit is a pregnant woman.

32. A support cushion according to claim 31, in which the second cushion part is configured to support a pregnant woman's swollen abdomen.

33. Use of the support cushion according to claim 18 by a recumbent person, wherein the distance between the cushion parts is adjusted by introducing folds into the connecting portion.

34. Use of a support cushion according to claim 18 by a person lying on their side, wherein the first cushion part is positioned to support the person's back or the front of the person's abdomen, the first portion of the second cushion part is positioned to support the front of the person's abdomen or the person's back, the second portion of the second cushion part is positioned to extend between the person's legs, and the connecting part is positioned to extend under the person's side in the region of the abdomen.

35. Use of a support cushion according to claim 18 when feeding a baby, wherein the second portion of the second cushion part is positioned to support the small of the mother's back, and the first portion of the second cushion part and the first cushion part are arranged to form a cradle in which the baby is held during feeding.
